(19) United States
(12) Patent Application Publication
(10) Pub. No.: US 2024/0255935 A1
(43) Pub. Date: Aug. 1, 2024

(54) SYSTEMS, APPARATUSES, METHODS, AND COMPUTER PROGRAM PRODUCTS FOR MACHINE LEARNING BASED CLASSIFICATION OF OPERATIONS DATA REPRESENTING OPERATIONS OF A PLANT

(71) Applicant: HONEYWELL INTERNATIONAL INC., Charlotte, NC (US)

(72) Inventors: Ramesh Murugan NATARAJAN, Bangalore (IN); Shahrul Azman Bin Zainal ABIDIN, Kuala Lumpur (MY); Madhukar Gundappa MADHAVAMURTHY, Bangalore (IN)

(21) Appl. No.: 18/184,898

(22) Filed: Mar. 16, 2023

(30) Foreign Application Priority Data
Jan. 30, 2023 (IN) 202311005914

(51) Int. Cl. G05B 19/418

(52) U.S. Cl. CPC G05B 19/41885

(57) ABSTRACT

Systems, apparatuses, methods, and computer program products for machine learning based classification of operations data representing operations of a plant are provided herein. In some embodiments, a computer-implemented method may include receiving the operations data representing the operations of the plant. In some embodiments, the operations data is associated with one or more data generation types. In some embodiments, the computer-implemented method may include applying the operations data to an operations data classification model. In some embodiments, the operations data classification model comprises a trained machine learning model that classifies the operations data into one or more classification levels based at least in part on the data generation type. In some embodiments, the computer-implemented method may include generating an operations data classification report that is specially configured based at least in part on the one or more classification levels and the operations data.

### TECHNOLOGICAL FIELD

Embodiments of the present disclosure relate generally to systems, apparatuses, methods, and computer program products for machine learning based classification of operations data representing operations of a plant.

### BACKGROUND

Applicant has identified many technical challenges and difficulties associated with systems, apparatuses, methods, and computer program products for machine learning based classification of operations data representing operations of a plant. Through applied effort, ingenuity, and innovation, Applicant has solved problems related to systems, apparatuses, methods, and computer program products for machine learning based classification of operations data representing operations of a plant by developing solutions embodied in the present disclosure, which are described in detail below.

### BRIEF SUMMARY

Various embodiments described herein relate to systems, apparatuses, methods, and computer program products for machine learning based classification of operations data representing operations of a plant.

In accordance with one aspect of the disclosure, a computer-implemented method for machine learning based classification of operations data representing operations of a plant is provided. In some embodiments, the computer-implemented method may include receiving the operations data representing the operations of the plant. In some embodiments, the operations data is associated with one or more data generation types. In some embodiments, the computer-implemented method may include applying the operations data to an operations data classification model. In some embodiments, the operations data classification model includes a trained machine learning model that classifies the operations data into one or more classification levels based at least in part on the one or more data generation types. In some embodiments, the computer-implemented method may include generating an operations data classification report that is specially configured based at least in part on the one or more classification levels and the operations data.

In some embodiments, the one or more data generation types include a source sampling type, a simulation model type, a process-based emission factors type, a survey type, a material balance type, a census-based emission factors type, and an extrapolation type.

In some embodiments, the one or more classification levels comprise a first level, a second level, a third level, a fourth level, and a fifth level.

In some embodiments, the first level is associated with an asset-based reporting, the second level is associated with source-based reporting, the third level is associated with source-based reporting and emissions factors-based reporting, the fourth level is associated with source-based reporting, emissions factors based-reporting, and activity factors-based reporting, and the fifth level is associated with emissions factors based-reporting, activity factors-based reporting, and plant measurement emissions based-reporting.

In some embodiments, the computer-implemented method may include generating a simulation model of the plant based at least in part on historical operations data. In some embodiments, the computer-implemented method may include applying the simulation model to generate an emissions dataset. In some embodiments, the emissions dataset includes a training emissions dataset and a test emissions dataset.

In some embodiments, the computer-implemented method may include training the trained machine learning model. In some embodiments, training the trained machine learning model includes applying, by the trained machine learning model, one or more machine learning techniques on the training emissions datasets to generate a trained emissions dataset and comparing the trained emissions dataset to the test emissions dataset.

In some embodiments, the clustering technique includes a k-means clustering technique.

In some embodiments, the one or more machine learning techniques includes a regression technique.

In some embodiments, the operations data classification report includes a plurality of classification sections, each classification section of the plurality of classification sections corresponding to one of the one or more classification levels.

In some embodiments, the computer-implemented method may include generating a user interface configured to display the operations data classification report.

In some embodiments, generating the user interface includes generating a plurality of classification interface components, each classification interface component configured to automatically display a corresponding classification section of the plurality of classification sections.

In some embodiments, each classification interface component is configured to automatically display the operations data classified into the classification level corresponding to the classification interface component.

In accordance with another aspect of the disclosure, an apparatus for machine learning based classification of operations data representing operations of a plant is provided. In some embodiments, the apparatus includes at least one processor and at least one non-transitory memory including computer-coded instructions thereon. In some embodiments, the apparatus may be caused to receive the operations data representing the operations of the plant. In some embodiments, the operations data is associated with one or more data generation types. In some embodiments, the apparatus may be caused to apply the operations data to an operations data classification model. In some embodiments, the operations data classification model includes a trained machine learning model that classifies the operations data into one or more classification levels based at least in part on the one or more data generation types. In some embodiments, the apparatus may be caused to generate an operations data classification report that is specially configured based at least in part on the one or more classification levels and the operations data.

In some embodiments, the one or more data generation types include a source sampling type, a simulation model type, a process-based emission factors type, a survey type, a material balance type, a census-based emission factors type, and an extrapolation type.

In some embodiments, the one or more classification levels comprise a first level, a second level, a third level, a fourth level, and a fifth level.

In some embodiments, the first level is associated with an asset-based reporting, the second level is associated with source-based reporting, the third level is associated with source-based reporting and emissions factors-based reporting, the fourth level is associated with source-based reporting, emissions factors based-reporting, and activity factors-based reporting, and the fifth level is associated with emissions factors based-reporting, activity factors-based reporting, and plant measurement emissions based-reporting.

In some embodiments, the apparatus may be caused to generate a simulation model of the plant based at least in part on historical operations data. In some embodiments the apparatus may be caused to apply the simulation model to generate an emissions dataset. In some embodiments, the emissions dataset includes a training emissions dataset and a test emissions dataset.

In some embodiments, the apparatus may be caused to train the trained machine learning model. In some embodiments, training the trained machine learning model includes applying, by the trained machine learning model, one or more machine learning techniques on the training emissions datasets to generate a trained emissions dataset and comparing the trained emissions dataset to the test emissions dataset.

In some embodiments, the clustering technique includes a k-means clustering technique.

In some embodiments, the one or more machine learning techniques includes a regression technique.

In some embodiments, the operations data classification report includes a plurality of classification sections, each classification section of the plurality of classification sections corresponding to one of the one or more classification levels.

In some embodiments, the apparatus may be caused to generate a user interface configured to display the operations data classification report.

In some embodiments, generating the user interface includes generating a plurality of classification interface components, each classification interface component configured to automatically display a corresponding classification section of the plurality of classification sections.

In some embodiments, each classification interface component is configured to automatically display the operations data classified into the classification level corresponding to the classification interface component.

In accordance with one aspect of the disclosure, a computer program product for machine learning based classification of operations data representing operations of a plant is provided. In some embodiments, the computer program product may include at least one non-transitory computer-readable storage medium having computer program code stored thereon. In some embodiments, the computer program product may be configured for receiving the operations data representing the operations of the plant. In some embodiments, the operations data is associated with one or more data generation types. In some embodiments, the computer program product may be configured for applying the operations data to an operations data classification model. In some embodiments, the operations data classification model includes a trained machine learning model that classifies the operations data into one or more classification levels based at least in part on the one or more data generation types. In some embodiments, the computer program product may be configured for generating an operations data classification report that is specially configured based at least in part on the one or more classification levels and the operations data.

In some embodiments, the one or more data generation types include a source sampling type, a simulation model type, a process-based emission factors type, a survey type, a material balance type, a census-based emission factors type, and an extrapolation type.

In some embodiments, the one or more classification levels comprise a first level, a second level, a third level, a fourth level, and a fifth level.

In some embodiments, the first level is associated with an asset-based reporting, the second level is associated with source-based reporting, the third level is associated with source-based reporting and emissions factors-based reporting, the fourth level is associated with source-based reporting, emissions factors based-reporting, and activity factors-based reporting, and the fifth level is associated with emissions factors based-reporting, activity factors-based reporting, and plant measurement emissions based-reporting.

In some embodiments the computer program product may be configured for generating a simulation model of the plant based at least in part on historical operations data. In some embodiments, the computer program product may be configured for applying the simulation model to generate an emissions dataset. In some embodiments, the emissions dataset includes a training emissions dataset and a test emissions dataset.

In some embodiments, the computer program product may be configured for training the trained machine learning model. In some embodiments, training the trained machine learning model includes applying, by the trained machine learning model, one or more machine learning techniques on the training emissions datasets to generate a trained emissions dataset and comparing the trained emissions dataset to the test emissions dataset.

In some embodiments, the clustering technique includes a k-means clustering technique.

In some embodiments, the one or more machine learning techniques includes a regression technique.

In some embodiments, the operations data classification report includes a plurality of classification sections, each classification section of the plurality of classification sections corresponding to one of the one or more classification levels.

In some embodiments, the computer program product may be configured for generating a user interface configured to display the operations data classification report.

In some embodiments, generating the user interface includes generating a plurality of classification interface components, each classification interface component configured to automatically display a corresponding classification section of the plurality of classification sections.

In some embodiments, each classification interface component is configured to automatically display the operations data classified into the classification level corresponding to the classification interface component.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates an exemplary block diagram of an environment in which embodiments of the present disclosure may operate;

FIG. 2 illustrates an exemplary block diagram of an example apparatus that may be specially configured in accordance with an example embodiment of the present disclosure;

FIG. 3 illustrates and example reliability and implementation difficulty graph in accordance with an example embodiment of the present disclosure;

FIG. 4 illustrates an exemplary simulation model in accordance with an example embodiment of the present disclosure;

FIG. 5 illustrates an example user interface in accordance with one or more embodiments of the present disclosure; and

FIG. 6 illustrates a flowchart of an example method in accordance with one or more embodiments of the present disclosure.

### DETAILED DESCRIPTION

Some embodiments of the present disclosure will now be described more fully herein with reference to the accompanying drawings, in which some, but not all, embodiments of the disclosure are shown. Indeed, various embodiments of the disclosure may be embodied in many different forms and should not be construed as limited to the embodiments set forth herein; rather, these embodiments are provided so that this disclosure will satisfy applicable legal requirements. Like reference numerals refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments or it may be excluded.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

As used herein the term “operations data” refers to electronically managed data representing operations of a particular processing unit of a particular processing plant, operations of a combination of processing units of a particular processing plant, and/or operations of a combination of processing units of a plurality of processing plants.

As used herein, the term “data generation type” refers to electronically managed data representing a methodology or procedure used to generate operations data.

As used herein, the term “classification level” refers to a manner in which operations data is to be grouped for processing, where one or more portions of operations data associated with one or more processing unit(s) are groupable based on a particular classification level.

As used herein, the term “operations data classification model” refers to an algorithmic, statistical, machine-learning, and/or artificial intelligence model that is configured to classify the operations data into one or more classification levels based at least in part on one or more of the one or more data generation types.

As used herein, the term “operations data classification report” refers to electronically managed data that represents electronically managed data including a structured representation of classification sections corresponding to one of the one or more classification levels, particular operations data, and/or data derived from one or more portion(s) of operations data.

### Overview

Example embodiments disclosed herein address technical problems associated with systems, apparatuses, methods, and computer program products for machine learning based classification of operations data representing operations of a plant. As would be understood by one skilled in the field to which this disclosure pertains, there are numerous example scenarios in which a user may use systems, apparatuses, methods, and computer program products for machine learning based classification of operations data representing operations of a plant.

In many plants (e.g., industrial plants, such as oil wells, oil refineries, chemical plants, natural gas processing plants, etc.), it is necessary to track plant emissions (e.g., emissions of greenhouse gasses by the plant) in order to meet regulatory and other requirements. For example, many enterprises (e.g., enterprises that own and/or operate plants) have made sustainability commitments to their shareholders, customers, regulators, employees, and/or the public in which they have committed to achieving substantial reductions in emissions in the near-term and long-term future. As such, in some examples, it is necessary for enterprises to accurately track and report their plant emissions to ensure that their plant emissions are meeting near-term and long-term emissions goals. In some examples, if an enterprise reports inaccurate plant emissions, substantial penalties and fines may be imposed on the enterprise. Accordingly, in some examples, when an enterprise reports plant emissions, it is necessary for the enterprise to indicate the reliability of the reported plant emissions, and in some examples generate a report accordingly.

Example solutions for indicating the reliability of reported plant emissions include receiving input data related to the emissions of the plant, classifying the input data into one or more reliability levels based on the reliability of the input data (e.g., representing how accurately the input data may represent the emissions of a plant), and then generating a report representing the input data, the reliability of the input data, and/or the plant emissions. The inventors have determined that the reliability of the input data may be affected by numerous factors that may not be readily apparent and/or known, and the inventors have determined that a result, it is often not possible to accurately classify input data into one or more reliability levels. Accordingly, there is a need for systems, apparatuses, methods, and computer program products for accurately classify input data based on reliability and generate structured report(s) accordingly.

Thus, to address these and/or other issues related to accurately classify input data based on reliability, systems, apparatuses, methods, and computer program products for machine learning based classification of operations data representing operations of a plant are disclosed herein. For example, some embodiments may include receiving the operations data representing the operations of the plant. In some embodiments, the operations data is associated with one or more data generation types. Some embodiments may include applying the operations data to an operations data classification model. In some embodiments, the operations data classification model comprises a trained machine learning model that classifies the operations data into one or more classification levels based at least in part on the data generation type. Some embodiments may include generating an operations data classification report that is specially configured based at least in part on the one or more classification levels and the operations data.

### Example Systems and Apparatuses

Embodiments of the present disclosure herein include systems, apparatuses, methods, and computer program products configured for and to perform one or more operations for machine learning based classification of operations data representing operations of a plant. It should be readily appreciated that the embodiments of the apparatus, systems, methods, and computer program product described herein may be configured in various additional and alternative manners in addition to those expressly described herein.

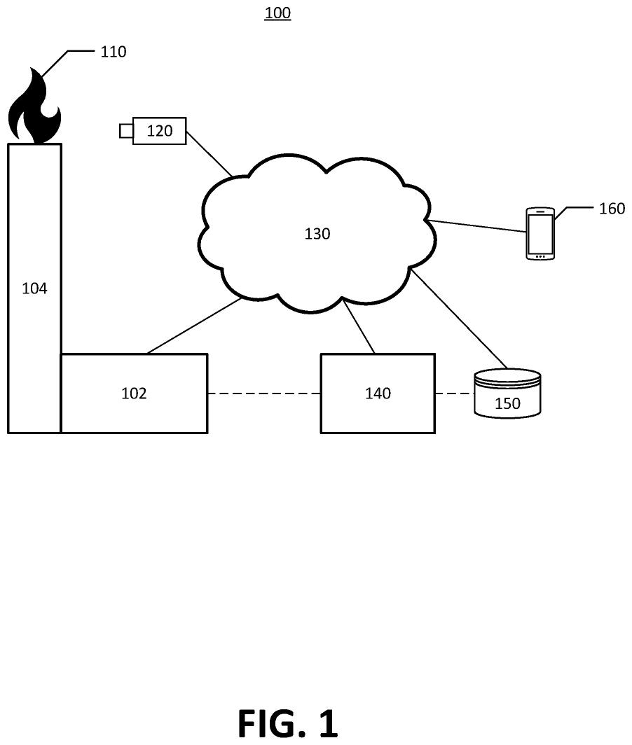

FIG. 1 illustrates an exemplary block diagram of an environment 100 in which embodiments of the present disclosure may operate. Specifically, FIG. 1 illustrates a plant 102 that may be associated with a flare stack 104 (“stack 104”). In some embodiments, the plant 102 embodies a processing plant associated with a particular operational goal. For example, in some embodiments, the embodies a processing plant including any number of processing unit(s) that, alone or in combination, perform a particular industrial process. In some embodiments, the plant 102 includes or embodies an oil refinery, petrochemical plant, chemical processing plant, or other plant that converts one or more ingredient(s) into a final product by performing particular operations that utilize, process, manipulate, and/or otherwise transform the ingredient(s). It will be appreciated that the depicted and described plant 102 defines non-limiting examples of components and/or operation of particular processing plant(s) and should not limit the scope and spirit of the disclosure to merely these configuration(s). For example, in some embodiments, the plant 102 includes the stack 104, while in other embodiments the plant 102 may not include any such stack.

In some embodiments, the plant 102 includes the stack 104 as a particular processing unit thereof. The stack 104 may be used to flare and/or vent one or more gases. These gases may include, but are not limited to, greenhouse gases. Flaring of gases may generate a flame 110. The flame 110 of a stack 104 may be observed, measured, analyzed by, and/or the like by one or more sensors 120 in accordance with operations and/or functions described herein. A sensor 120 may generate and/or transmit sensor data across a network 130 to an operations processing system 140. The operations processing system 140 may be electronically and/or communicatively coupled to one or more plant(s), for example to plant 102, one or more databases 150, and the user device 160. In some embodiments, the plant 102 embodies or includes a different type of processing plant, and/or does not include the flare stack 104. For example, in some embodiments, the plant 102 includes any number of processing units that each perform different tasks for producing a final product (e.g., a blended, constructed, or otherwise combined product) from one or more input ingredients.

The plant 102 may for example, be processing plant that receives and processes ingredients as inputs to create a final product, such as a hydrocarbon processing plant, a refinery plant, a drilling plant, and/or a fracking plant. The plant 102 may generate gasses (e.g., waste gases). In various embodiments, gasses may be released to atmosphere, such as through a stack 104. Additionally or alternatively, gases may be flared when being released to atmosphere. Additionally, or alternatively, flaring and venting of gases may occur at locations other than a stack 104. For example, smaller quantities of gases at other locations may be released or may leak into the atmosphere. In some embodiments, locations other than a stack 104 where gases may be vented and/or flared may include well heads, safety release valves, pipe headers, and/or the like.

The plant 102 in some embodiments includes any number of individual processing units. The processing units may each embody an asset of the plant 102 that performs a particular function during operation of the plant 102. For example in the example context of a hydrocarbon processing plant, a refinery plant, a drilling plant, and/or a fracking plant embodying the plant 102, the processing units may include one or more crude processing units, hydrotreating units, isomerization units, vapor recovery units, catalytic cracking units, aromatics reduction units, visbreaker units, storage tank units, blender units, pump units, venting units, compressor units, cooler units (e.g., air cooler units), sensor units, flare units (e.g., the stack 104), and/or the like that perform a particular operation for transforming, storing, releasing and/or otherwise handling one or more input ingredient(s) (e.g., hydrocarbons, gases, etc.). In some embodiments, the one or more sensor units may include one or more flow rate sensors, temperature sensors, pressure sensors, humidity sensors, image sensors, density sensors, material composition sensors (e.g., spectrometers, spectrophotometers, etc.), and/or the like. In some embodiments, one or more of the one or more processing units may generate gasses (e.g., greenhouse gasses). In some embodiments, these gases may be released to the atmosphere, such as through the stack 104 and/or directly by each of the processing units.

In some embodiments, each individual unit embodying a component of the plant 102 is associated with a determinable location. The determinable location of a particular unit in some embodiments represents an absolute position (e.g., GPS coordinates, latitude and longitude locations, and/or the like) or a relative position (e.g., a point representation of the location of a unit from a local origin point corresponding to the plant 102). In some embodiments, a unit includes or otherwise is associated with a location sensor and/or software-driven location services that provide the location data representing the location corresponding to that unit. In other embodiments the location of a unit is stored and/or otherwise predetermined within a software environment, provided by a user and/or otherwise determinable to one or more systems, for example including the operations processing system 140.

Additionally or alternatively, in some embodiments, the plant 102 itself is associated with a determinable location. The determinable location of the plant 102 in some embodiments represents an absolute position (e.g., GPS coordinates, latitude and longitude locations, an address, and/or the like) or a relative position of the plant 102 (e.g., an identifier representing the location of the plant 102 as compared to one or more other plants, an enterprise headquarters, or general description in the world for example based at least in part on continent, state, or other definable region). In some embodiments, the plant 102 includes or otherwise is associated with a location sensor and/or software-driven location services that provide the location data corresponding to the plant 102. In other embodiments, the location of the plant 102 is stored and/or otherwise determinable to one or more systems, for example including the operations processing system 140.

The flame 110 may be associated with flaring. Flaring involves the igniting and burning of concentrations of flammable gases. A gas may be comprised of a plurality of concentrations of individual gases, and some of these concentrations of individual gases may be flammable. Alternatively, a gas may be comprised of a concentration of an individual gas, which may or may not be flammable. In some embodiments, a gas may contain greenhouse gases, such as hydrocarbons. The hydrocarbons may be ignited by an ignition source, such as a pilot flame, when the gas passes by the ignition source. The ignited gas(es) may be referred to as flares, and this process may be referred to as flaring. In various embodiments, flaring may occur at the flaring stack 104, which may be at a high level of elevation from one or more other components of a plant 102, process area, piping, and the like associated with a site.

In embodiments with gases comprising hydrocarbons, the flaring of hydrocarbons will include lower emissions than the venting of the same gas(es). This is because flaring converts the hydrocarbons in the gas(es) to CO2 and water while venting does not change the composition of the waste gas to water. Thus the flaring may reduce the emissions of hydrocarbons into the atmosphere. In contrast to flaring, venting does not use combustion and, instead, is a direct release of gas(es) to the atmosphere. While FIG. 1 illustrates a flame 110, it will also be appreciated that by removing or omitting an ignition source, such as a pilot flame, gas(es) may be vented without flaring.

The one or more sensors 120 may include sensors to detect, measure, and/or analyze data associated with operation of one or more plant(s), for example the plant 102. In one such example context, the sensors detect, measure, and/or analyze a flame 110 and/or a gas emission, for example associated with a flaring and/or a venting. In some embodiments, a sensor 120 may include a camera, which may be configured to capture images and/or video in one or more spectrums of light. For example, a camera may be configured to capture images and/or video in the visible spectrum. Additional, and/or alternatively, a camera may be configured to capture images and/or video in the infrared spectrum. It will be appreciated that any number of sensor(s), sensor type(s), and/or the like may be utilized to monitor operations of a particular plant, and/or multiple plant(s).

In some embodiments, a sensor 120 (e.g., a camera) may be configured to perform or execute one or more operations and/or functions with determining a type, quantity, and/or volume of gas flared and/or emitted. For example, a camera may capture both visible light and infrared light to generate images and/or video of flaring. Based on these images and/or video of flaring, the camera may determine a type of gas being in a flame 110 as well as a volume of gas flared. In another example with a gas emission that is vented and not flared, a camera may capture both visible light and infrared light to generate images and/or video of venting. Based on these images and/or video of venting, the camera may determine a type of gas being in a flame 110 as well as a volume of gas flared. In various embodiments, a sensor 120 may generate sensor data (e.g., a camera generating images and/or video) and transmit the sensor data over a network 130.

The network 130 may be embodied in any of a myriad of network configurations. In some embodiments, the network 130 may be a public network (e.g., the Internet). In some embodiments, the network 130 may be a private a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

The operations processing system 140 may be located remotely or in proximity of a particular plant, for example the plant 102. In this regard, in some embodiments, the operations processing system 140 may be located remotely or in proximity to the emissions sources, such as flame 110. In some embodiments, the operations processing system 140 is configured via hardware, software, firmware, and/or a combination thereof, to perform data intake of one or more types of data associated with one or more plant(s), for example the plant 102. Additionally or alternatively, in some embodiments, the operations processing system 140 is configured via hardware, software, firmware, and/or a combination thereof, to generate and/or transmit command(s) that control, adjust, or otherwise impact operations of a particular plant or specific component(s) thereof, for example for controlling one or more operations of the plant 102. Additionally or alternatively still, in some embodiments, the operations processing system 140 is configured via hardware, software, firmware, and/or a combination thereof, to perform data reporting and/or other data output process(es) associated with monitoring or otherwise analyzing operations of one or more processing plant(s), for example for generating and/or outputting report(s) corresponding to the operations performed via the plant 102. For example, in various embodiments, the operations processing system 140 may be configured to execute and/or perform one or more operations and/or functions described herein.

The one or more databases 150 may be configured to receive, store, and/or transmit data. In some embodiments, the one or more databases 150 may be associated with operations data received from the plant 102, such as from the one or more sensor units of the plant 102. Additionally or alternatively, the one or more databases 150 may be associated with operations data received from the plant 102 in real-time, such as from the one or more sensor units of the plant 102. Additionally or alternatively, the one or more databases 150 may be associated with historical operations data received from the plant 102, such as from the one or more sensor units of the plant 102. Additionally or alternatively, in some embodiments the one or more databases 150 store user inputted data associated with operations of one or more plant(s). In some embodiments, the one or more databases 150 store data associated with multiple individual plant(s), for example multiple plants associated with the same enterprise entity but located in different geographic locations across the world.

The user device 160 may be associated with users of the operations processing system 140. In various embodiments, the operations processing system 140 may generate and/or transmit a message, alert, or indication to a user via a user device 160. Additionally, or alternatively, a user device 160 may be utilized by a user to remotely access an operations processing system 140. This may be by, for example, an application operating on the user device 160. A user may access the operations processing system 140 remotely, including one or more visualizations, reports, and/or real-time displays.

Additionally, while FIG. 1 illustrates certain components as separate, standalone entities communicating over the network 130, various embodiments are not limited to this configuration. In other embodiments, one or more components may be directly connected and/or share hardware or the like. For example, in some embodiments, the operations processing system 140 may include one or more databases 150, which may collectively be located in or at the plant 102.

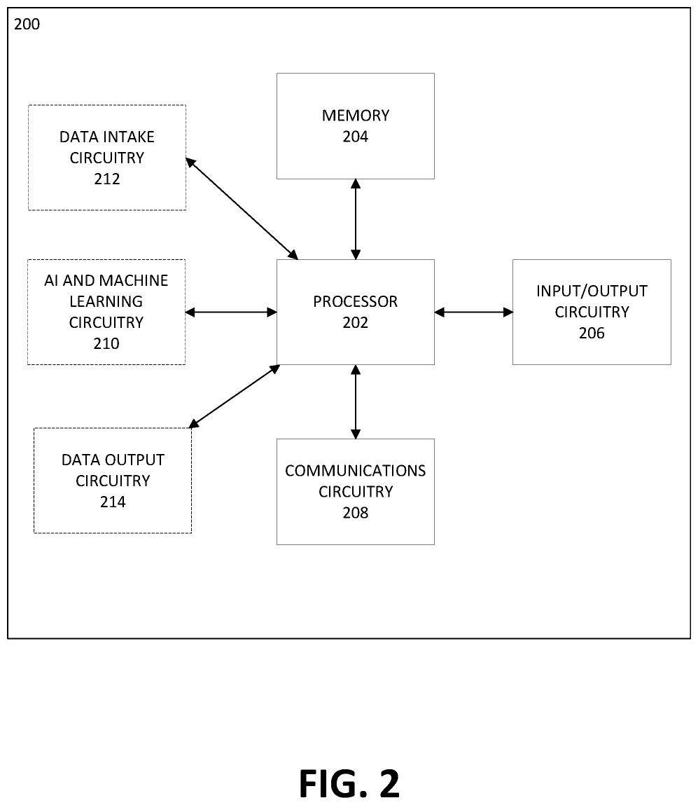

FIG. 2 illustrates an exemplary block diagram of an example apparatus that may be specially configured in accordance with an example embodiment of the present disclosure. Specifically, FIG. 2 depicts an example computing apparatus embodying a data reporting apparatus 200 (“apparatus 200”) specially configured in accordance with at least some example embodiments of the present disclosure. Examples of an apparatus 200 may include, but is not limited to, a sensor 120, the operations processing system 140, the one or more databases 150, and/or a user device 160. The apparatus 200 includes processor 202, memory 204, input/output circuitry 206, communications circuitry 208, and/or optional artificial intelligence (“AI”) and machine learning circuitry 210. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory/memories, circuitry/circuitries, and/or the like to perform their associated functions such that duplicate hardware is not required for each set of circuitry.

In various embodiments, such as a computing apparatus 200 of an operations processing system 140 or of a user device 160 may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuity 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200. Memory 204 or memory circuitry 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device, one or more sensors, and/or other external computing device(s) in communication with the apparatus 200.

Data intake circuitry 212 may be included in the apparatus 200. The data intake circuitry 212 may include hardware, software, firmware, and/or a combination thereof, designed and/or configured to capture, receive, request, and/or otherwise gather data associated with operations of one or more plant(s). In some embodiments, the data intake circuitry 212 includes hardware, software, firmware, and/or a combination thereof, that communicates with one or more sensor(s). unit(s), and/or the like within a particular plant to receive particular data associated with such operations of the plant. The data intake circuitry 212 may support such operations for any number of individual plants. Additionally or alternatively, in some embodiments, the data intake circuitry 212 includes hardware, software, firmware, and/or a combination thereof, that retrieves particular data associated with one or more plant(s) from one or more data repository/repositories accessible to the apparatus 200.

AI and machine learning circuitry 210 may be included in the apparatus 200. The AI and machine learning circuitry 210 may include hardware, software, firmware, and/or a combination thereof designed and/or configured to request, receive, process, generate, and transmit data, data structures, control signals, and electronic information for training and executing a trained AI and machine learning model configured to facilitating the operations and/or functionalities described herein. For example, in some embodiments the AI and machine learning circuitry 210 includes hardware, software, firmware, and/or a combination thereof, that identifies training data and/or utilizes such training data for training a particular machine learning model, AI, and/or other model to generate particular output data based at least in part on learnings from the training data. Additionally or alternatively, in some embodiments, the AI and machine learning circuitry 210 includes hardware, software, firmware, and/or a combination thereof, that embodies or retrieves a trained machine learning model, AI and/or other specially configured model utilized to process inputted data. Additionally or alternatively, in some embodiments, the AI and machine learning circuitry 210 includes hardware, software, firmware, and/or a combination thereof that processes received data utilizing one or more algorithm(s), function(s), subroutine(s), and/or the like, in one or more pre-processing and/or subsequent operations that need not utilize a machine learning or AI model.

Data output circuitry 214 may be included in the apparatus 200. The data output circuitry 214 may include hardware, software, firmware, and/or a combination thereof, that configures and/or generates an output based at least in part on data processed by the apparatus 200. In some embodiments, the data output circuitry 214 includes hardware, software, firmware, and/or a combination thereof, that generates a particular report based at least in part on the processed data, for example where the report is generated based at least in part on a particular reporting protocol. Additionally or alternatively, in some embodiments, the data output circuitry 214 includes hardware, software, firmware, and/or a combination thereof, that configures a particular output data object, output data file, and/or user interface for storing, transmitting, and/or displaying. For example, in some embodiments, the data output circuitry 214 generates and/or specially configures a particular data output for transmission to another system sub-system for further processing. Additionally or alternatively, in some embodiments, the data output circuitry 214 includes hardware, software, firmware, and/or a combination thereof, that causes rendering of a specially configured user interface based at least in part on data received by and/or processing by the apparatus 200.

In some embodiments, two or more of the sets of circuitries 202-214 are combinable. Alternatively, or additionally, one or more of the sets of circuitry 202-214 perform some or all of the operations and/or functionality described herein as being associated with another circuitry. In some embodiments, two or more of the sets of circuitry 202-214 are combined into a single module embodied in hardware, software, firmware, and/or a combination thereof. For example, in some embodiments, one or more of the sets of circuitry, for example the AI and machine learning circuitry 210, may be combined with the processor 202, such that the processor 202 performs one or more of the operations described herein with respect the AI and machine learning circuitry 210.

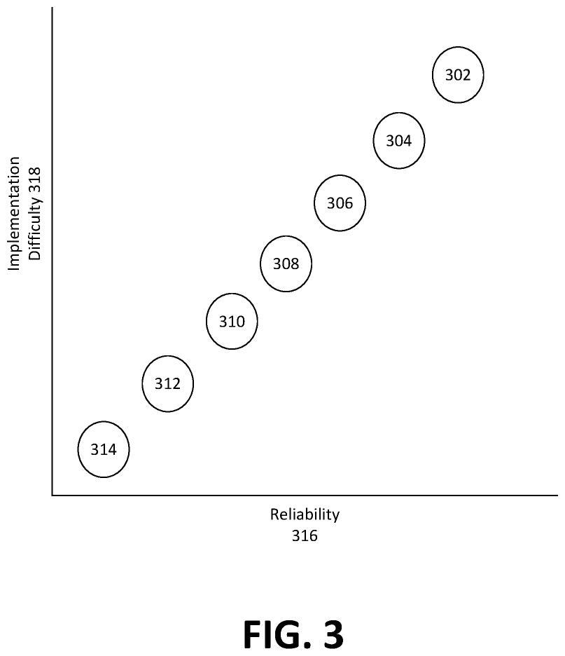

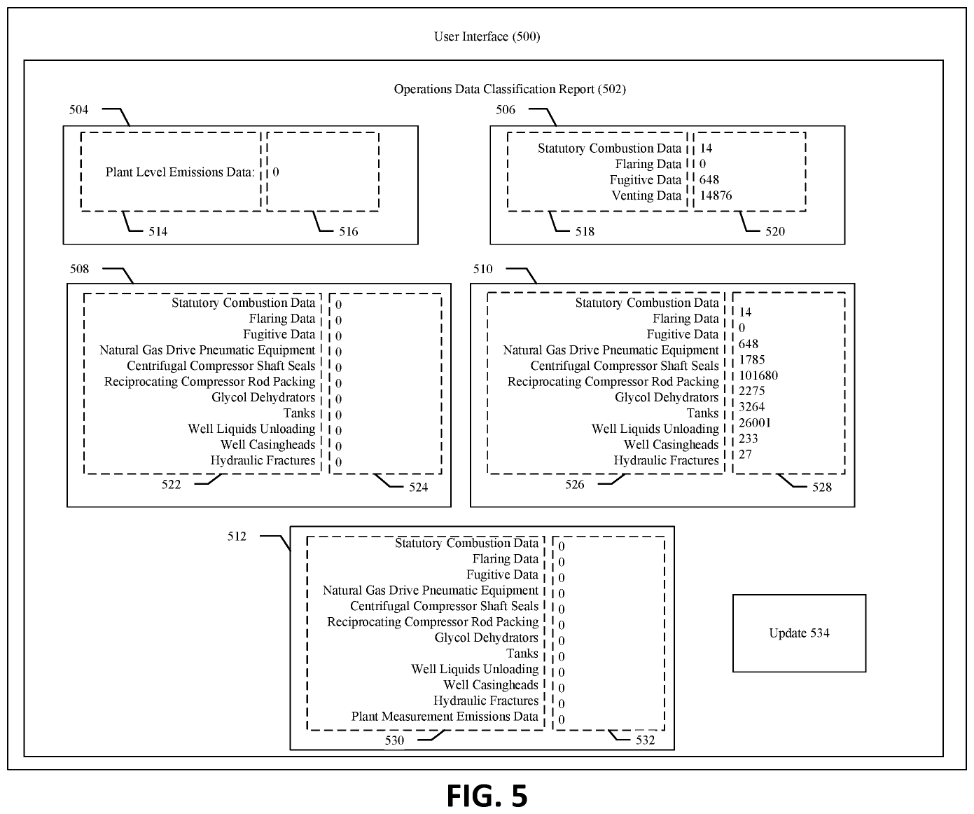

With reference, to FIGS. 1-5 in some embodiments, the operations processing system 140 and/or the user device 160 may be configured to receive operations data representing operations of the plant 102. For example, using the data intake circuitry 212. In some embodiments, the operations data may include one or more of plant component identifiers, plant production capacity data, plant efficiency data, plant process data, flow rate data, temperature data, pressure data, volume data, oxygen input data, material composition data, weather data, stationary combustion data, flaring data, fugitive data, venting data, plant level emissions data and/or plant measurement emissions data.

In some embodiments, as an example, the plant component identifiers may indicate whether the plant 102 has one or more well units, fracking units, crude processing units, hydrotreating units, isomerization units, vapor recovery units, catalytic cracking units, aromatics reduction units, visbreaker units, storage tank units, blender units, pump units, venting units, compressor units, cooler units (e.g., air cooler units), sensor units, flare units (e.g., the stack 104). As another example, the production capacity may indicate how much final product (e.g., refined oil) the plant 102 may be capable of producing (e.g., how much final product the plant 102 may be capable of producing within allowable safety limits). As another example, plant efficiency data may indicate the efficiency of one or more processes the plant 102 is performing. As another example, plant process data may indicate the process (e.g., the order of operations for one or more tasks) the plant 102 performs in order to produce a final product from one or more input ingredients. As another example, flow rate data may include the flow rate of various fluids in different locations throughout the plant (e.g., the flow rate of gas in the stack 104). As another example, the temperature data may indicate the temperature at various locations in the plant 102 (e.g., temperature in the stack 104) and/or the boiling point of various fluids in the plant 102. As another example, the pressure data may indicate the pressure (e.g., the pressure of gas in the stack 104) at various locations in the plant 102. As another example, the volume data may indicate the volume (e.g., fluid level in a storage tank) at various locations in the plant 102. As another example, the oxygen input data may indicate how much oxygen the plant 102 is mixing with the gas before the gas passes by the ignition source and/or simultaneously as the gas passes by the ignition source of the stack 104. As another example, the material composition data may indicate various properties of a final product the plant 102 is producing (e.g., refined oil) and/or input ingredients the plant 102 is using to produce the final product (e.g., unrefined oil), such as purity, density, viscosity, impurities, and/or the like. As another example, the weather data may indicate the weather around the plant 102 (e.g., the temperature around the plant 102, wind speed around the plant 102, humidity around the plant 102, precipitation around the plant 102, etc.). As another example, the stationary combustion data may indicate emissions of the plant 102 due to stationary combustion at the plant 102. As another example, flaring data may indicate emissions of the plant 102 due to flaring at the plant 102. As another example, fugitive data may indicate fugitive emissions of the plant 102. As another example, venting data may indicate emissions of the plant 102 due to venting at the plant 102. In some embodiments, venting data may indicate emissions of the plant 102 due to venting associated with one or more of natural gas driven pneumatic equipment, centrifugal compressor shaft seals, reciprocating compressor rod packing, glycol dehydrators, tanks, well liquids unloading, well casingheads, hydraulic fractures, and/or the like. As another example, the plant level emissions data may indicate total emissions of the plant 102. As another example, plant measurement emissions data may indicate measured emissions at the plant 102.

In some embodiments, the operations processing system 140 and/or the user device 160 may be configured to generate at least some of the operations data from operations data received by the operations processing system 140 and/or the user device 160. In this regard, for example, the operations processing system 140 and/or the user device 160 may be configured to generate at least some of the operations data when the received operations data only includes some of the operations data. For example, the operations processing system 140 and/or the user device 160 may receive flow rate data, but not venting data. In this regard, for example, the operations processing system 140 and/or the user device 160 may be configured to generate venting data from the flow rate data (e.g., the flow rate data indicate the flow rate of gas moving through a venting unit of the plant such that the operations processing system 140 and/or the user device 160 may determine the venting data from the flow rate data).

In some embodiments, the operations data may be associated with one or more data generation types. The data generation types may include one or more of a source sampling type 302, a simulation model type 304, a process-based emission factors type 306, a survey type 308, a material balance type 310, a census-based emission factors type 312, and/or an extrapolation type 314. In some embodiments, each data generation type may indicate a methodology or procedure used to generate some or all of the operations data.

In some embodiments, for example, operations data associated with the source sampling type 302 may be operations data generated via direct measurements at the plant 102 (e.g., a direct measurement of the emissions of the plant 102 due to venting, the flow rate of gases in the plant 102, etc.). As another example, operations data associated with the simulation model type 304 may be operations data generated via a simulation model of the plant 102 (e.g., a simulation model is applied to determine the emissions of the plant 102 due to venting, the flow rate of gases in the plant 102, etc.). As another example, operations data associated with process-based emission factors type 306 may be operations data generated via an emissions factor based on specific attributes of the plant 102, such as particular processing performed by a particular processing unit of the plant 102(e.g., a process-based emissions factor is used to determine the emissions of the plant 102 due to venting from a compressor unit in the plant 102, etc.) As another example, operations data associated with the survey type 308 may be operations data generated via a survey of historical emissions factors associated with an industry similar to the plant 102 and/or processing units similar to the processing units associated with the plant 102 (e.g., a survey of historical emissions factors related to a compressor unit similar to a compressor unit at the plant 102). As another example, operations data associated with the material balance type 310 may be operations data generated via a measure of the material processed by the plant 102 (e.g., the raw material that the plant 102 process). As another example, operations data associated with census-based emission factors type 312 may be operations data generated via an emissions factor based on historical emissions factors associated with an industry similar to the plant 102 and/or a location similar to the plant 102 (e.g., a census-based emissions factor is used to determine the emissions of the plant 102 due to venting based on venting at a different plant in a similar location to the plant 102, etc.) As another example, operations data associated with the extrapolation type 314 may be operations data generated based on previous operations data of the plant 102 (e.g., historical operations data).

In some embodiments, each data generation type may be associated with a reliability 316. The reliability 316 associated with each of the data generation types may indicate how reliable each data generation type is in generating operations data that represents the actual operations of the plant 102 (e.g., how close the emissions of the plant 102 due to venting as indicated by the venting data versus the actual emissions of the plant 102 due to venting). In some embodiments, the reliability 316 of each data generation type may be different. For example, the reliability 316 of the source sampling type 302 may be greater than the reliability 316 of the extrapolation type 314. Additionally or alternatively, each data generation types may be associated with an implementation difficulty 318. The implementation difficulty 318 associated with each data generation types may indicate the difficulty to generate the operations data using each data generation type (e.g., how much it costs, how much time it takes, etc.). In some embodiments, the implementation difficulty 318 of each data generation type may be different. For example, the implementation difficulty 318 of the source sampling type 302 may be greater than the implementation difficulty 318 of the extrapolation type 314.

In some embodiments, the operations processing system 140 and/or the user device 160 may be configured to apply the operations data to an operations data classification model. In some embodiments, the operations data classification model may include a trained machine learning model that classifies the operations data into one or more classification levels based at least in part on one or more of the one or more data generation types. In this regard, the one or more classification levels may include a first level, a second level, a third level, a fourth level, and a fifth level. In some embodiments, the first level is associated with an asset-based reporting, the second level is associated with source-based reporting, the third level is associated with source-based reporting and emissions factors-based reporting, the fourth level is associated with source-based reporting, emissions factors based-reporting, and activity factors-based reporting, and the fifth level is associated with emissions factors based-reporting, activity factors-based reporting, and plant measurement emissions based-reporting. For example, asset-based reporting may include operations data that indicates the total emissions of an asset, such as the plant 102 (e.g., plant level emissions data). As another example, source-based reporting may include operations data indicating emissions associated with one or more units (e.g., a venting unit) of an asset, such as the plant 102 (e.g., venting data). As another example, emissions factors based-reporting may include operations data indicating emissions associated with one or more emissions factors associated with the plant 102. As another example, activity factors may include operations data indicating emissions associated with a measured quantity associated with a particular activity at the plant 102 (e.g., venting data indicating measured emissions due to venting when a compressor unit starts). As another example, plant measurement emissions based-reporting may indicate emissions measured at the plant 102 (e.g., plant measurement emissions data).

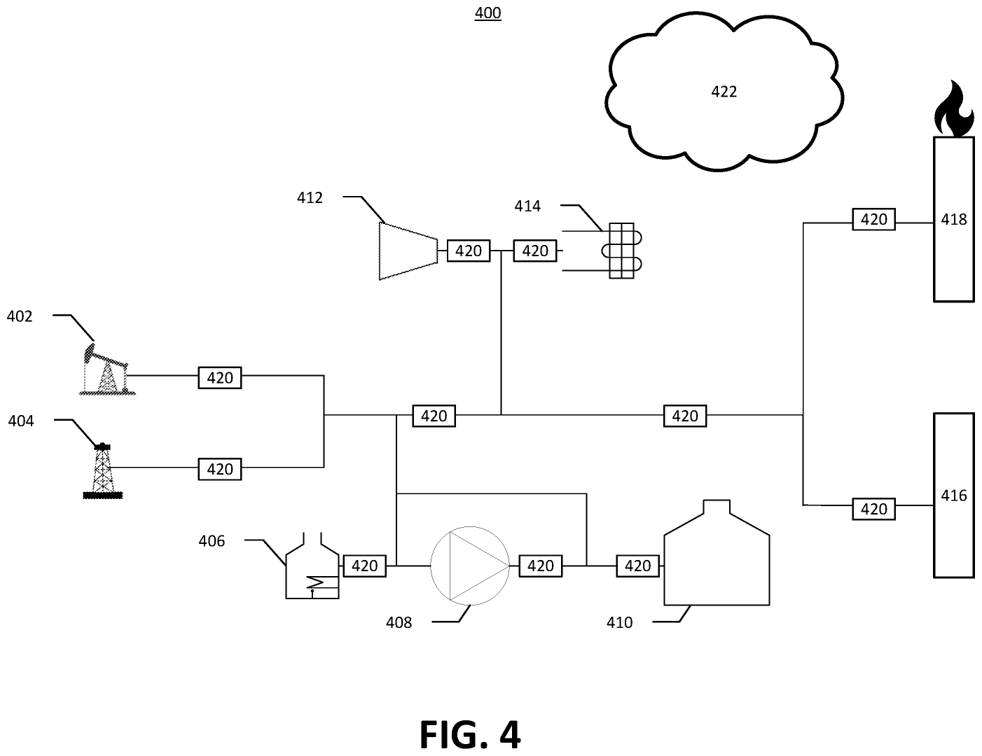

In some embodiments, the operations processing system 140 and/or the user device 160 may be configured to generate a simulation model 400 of the plant 102 based at least in part on the operations data and/or historical operations data (e.g., the historical operations data associated with the one or more databases 150), such as the simulation model 400 depicted in FIG. 4. In some embodiments, the simulation model 400 may be a computer model representation of the plant 102 based on the operations data and/or historical operations data. In this regard, for example, the simulation model 400 may include one or more well components 402, fracking components 404, heater components 406, pump components 408, storage tank components 410, venting components 416, compressor components, cooler components 414, sensor components 420, flare components 418, and/or weather components 422. In some embodiments, the components included in the simulation model 400 may be based on the operations data and/or the historical operations data. For example, if the operations data and/or the historical operations data includes a plant component identifier that indicates the plant 102 has one or more fracking components 404, the simulation model 400 may include one or more fracking components 404. As another example, if the operations data and/or the historical operations data includes flow rate data, the simulation model 400 may include one or more sensor components 420 corresponding to a flow sensor. As another example, if the operations data and/or the historical operations data indicates wind speed around the plant 102, the simulation model 400 may include one or more weather components 422 corresponding to the wind speed around the plant 102.

Although depicted as separate components of the simulation model 400, it would be understood by one skilled in the field to which this disclosure pertains that some or all of the components may be combined with other components of the simulation model 400. For example, the one or more well components 402 and the one or more fracking components 404 may be combined into a single component. As another example, the one or more venting components 416 and the one or more flare components 418 may be combined into a single component. Additionally, it would be understood by one skilled in the field to which this disclosure pertains that the simulation model 400 may have more or fewer components.

In some embodiments, the operations processing system 140 and/or the user device 160 may be configured to apply the simulation model 400 to generate an emissions dataset. In some embodiments, the emissions dataset may include a training emissions dataset and/or a test emissions dataset (e.g., the emissions dataset may be divided into a training emissions dataset and/or a test emissions dataset). In some embodiments, the emissions dataset may comprise data that indicates the emissions of the plant 102. In this regard, applying the simulation model 400 to generate the emissions dataset may include the simulation model 400 determining one or more physical properties or chemical properties associated with the plant 102. For example, the one or more physical properties associated with the plant 102 may include one or more of a melting point associated with a product produced by the plant 102 and/or input ingredient used by the plant 102 and/or a molecular weight associated with a product produced by the plant 102 and/or input ingredient used by the plant 102. As another example, the one or more chemical properties associated with the plant 102 may include one or more of a flammability associated with a product produced by the plant 102 and/or input ingredient used by the plant 102 (e.g., gas in the stack 104) and/or a pH value associated with a product produced by the plant 102 and/or input ingredient used by the plant 102. Said differently, the emissions data set may include the one or more physical or chemical properties determined by applying the simulation model 400 such that the emissions dataset includes data that indicates the emissions of the plant 102.

Although described herein with respect to the operations processing system 140 and/or the user device 160 applying the simulation model 400 to generate an emissions dataset, it would be understood by one skilled in the field to which this disclosure pertains that the operations processing system 140 and/or the user device 160 may generate the emissions dataset without applying the simulation model 400. For example, the operations processing system 140 and/or the user device 160 may be configured to generate the emissions dataset directly from the operations data and/or the historical operations data (e.g., the operations data and/or the historical operations data is organized into the emissions dataset).

In some embodiments, the operations processing system 140 and/or the user device 160 may be configured to train the trained machine learning model (e.g., using AI and machine learning circuitry 210). In some embodiments, training the machine learning model may include the trained machine learning model applying one or more machine learning techniques on the training emissions dataset to generate a trained emissions dataset. In some embodiments, the one or more machine learning techniques may be an unsupervised learning technique, such as a clustering technique. For example, the clustering technique may be a k-means clustering technique. In this regard, applying one or more machine learning techniques on the training emissions dataset may include iteratively grouping data in the training emissions dataset into clusters, where the data in each cluster has similar characteristics, to generate the trained emissions dataset. Additionally or alternatively, the one or more machine learning techniques may include a supervised learning technique, such as a regression technique. In some embodiments, after generating the trained emissions dataset, the operations processing system 140 and/or the user device 160 may be configured to compare the trained emissions dataset to the test dataset. In this regard, a confidence level may be calculated indicating the accuracy of the trained emissions dataset.

In some embodiments, the operations processing system 140 and/or the user device 160 may be configured to generate an operations data classification report 502 based at least in part on the one or more classification levels and/or the operations data. For example, using the data output circuitry 214. In some embodiments, the operations data classification report 502 may include a plurality of classification sections. In some embodiments, each classification section of the plurality of classification sections may correspond to one of the one or more classification levels. In this regard, for example, the operations data classification report 502 may include a first level classification section, a second level classification section, a third level classification section, a fourth level classification section, and a fifth level classification section. In some embodiments, each classification section is specially configured based at least in part on corresponding data corresponding to a particular classification level of the one or more classification levels.

In some embodiments, the operations processing system 140 and/or the user device 160 may be configured to generate a user interface 500. In some embodiments, the user interface 500 embodies a user interface configured to be rendered to a native application associated with the operations processing system 140, the user device 160, and/or another computing device, for example (e.g., using the data output circuitry 214). In some embodiments, the user interface 500 embodies a web interface accessible by a browser or other web application (e.g., via the data output circuitry 214). In this regard, for example, the user interface 500 may be accessible by a browser or other web application associated with the operations processing system 140, the user device 160, and/or another computing device, for example.

In some embodiments, the user interface 500 may be configured to display the operations data classification report 502. In some embodiments, generating the user interface 500 includes generating a plurality of classification interface components with each classification interface component configured to automatically display a corresponding classification section of the plurality of classification sections of the operations data classification report 502. For example, the plurality of classification interface components may include a first level classification interface component 504 corresponding to the first level, a second level classification interface component 506 corresponding to the second level, a third level classification interface component 508 corresponding to the third level, a fourth level classification interface component 510 corresponding to the fourth level, and a fifth level classification interface component 512 corresponding to the fifth level.

In some embodiments, each of the plurality of classification interface components may be configured to automatically display the operations data classified into the classification level corresponding the classification interface component (e.g., automatically after the trained machine learning model has classified the operations data into the one or more classification levels). For example, the first level classification interface component 504 may automatically display a plurality of first level operations data 514. As another example, the second level classification interface component 506 may automatically display a plurality of second level operations data 518. As another example, the third level classification interface component 508 may automatically display a plurality of third level operations data 522. As another example, the fourth level classification interface component 510 may automatically display a plurality of fourth level operations data 526. As another example, the fifth level classification interface component 512 may automatically display a plurality of fifth level operations data 530.

In some embodiments, each of the plurality of classification interface components may be configured to automatically display particular emissions values associated with the operations data in each classification level. For example, the first level classification interface component 504 may include first level emissions values 516. For example, the second level classification interface component 506 may plurality of second level emissions values 520. For example, the third level classification interface component 508 may a plurality of third level emissions values 524. For example, the fourth level classification interface component 510 may a plurality of fourth level emissions values 528. For example, the fifth level classification interface component 512 may a plurality of fifth level emissions values 532. In some embodiments, the particular emissions values may be indicative of one or more greenhouse gases (e.g., methane) related to the associated operations data.

In some embodiments, the operations processing system 140 and/or the user device 160 may be configured to update the user interface 500. In this regard, for example, the operations data and/or the particular emissions values associated with the operations data in one or more of the classification interface components may be updated. In some embodiments, the user interface 500 may be updated via user selection. For example, a user may update the user interface 500 via update component 534. In some embodiments, the user interface 500 may be updated in real-time. For example, the user interface 500 may be updated as operations data is received by the operations processing system 140 and/or the user device 160 and/or as the trained machine learning model classifies the operations data into the one or more classification levels. In some embodiments, the user interface 500 may be updated on a periodic basis. For example, the user interface 500 may be updated one per hour, once per day, once per week, once per month, once per quarter, etc.

### Example Methods

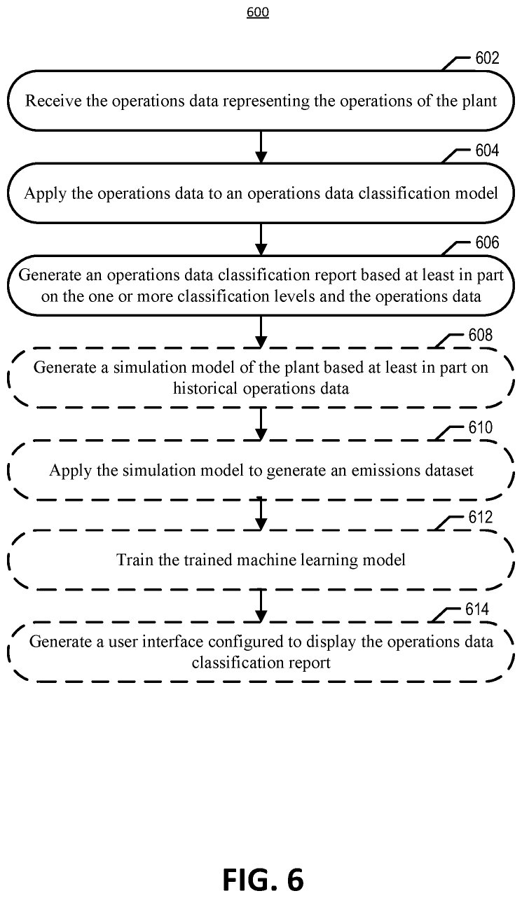

Referring now to FIG. 6, a flowchart providing an example method 600 for machine learning based classification of operations data representing operations of a plant is illustrated. In this regard, FIG. 6 illustrates operations that may be performed by the operations processing system 140 and/or the user device 160, the plant 102, the stack 104, the flame 110, and/or the like. In some embodiments, the example method 600 defines a computer-implemented process, which may be executable by any of the device(s) and/or system(s) embodied in hardware, software, firmware, and/or a combination thereof, as described herein. For example, in some embodiments each of the example method(s) as described herein embodies a computer-implemented method executable via the apparatus 200 as depicted and described herein. In some embodiments, computer program code including one or more computer-coded instructions are stored to at least one non-transitory computer-readable storage medium, such that execution of the computer program code initiates performance of the method 600.

As shown in block 602, the method for machine learning based classification of operations data representing operations of a plant may include receiving the operations data representing the operations of the plant. As described above, in some embodiments, the operations data may include one or more of plant component identifiers, plant production capacity data, plant efficiency data, plant process data, flow rate data, temperature data, pressure data, volume data, oxygen input data, material composition data, weather data, stationary combustion data, flaring data, fugitive data, venting data, plant level emissions data and/or plant measurement emissions data.

In some embodiments, for example, the plant component identifiers may indicate whether the plant has one or more well units, fracking units, crude processing units, hydrotreating units, isomerization units, vapor recovery units, catalytic cracking units, aromatics reduction units, visbreaker units, storage tank units, blender units, pump units, venting units, compressor units, cooler units (e.g., air cooler units), sensor units, flare units (e.g., the stack). As another example, the production capacity may indicate how much final product (e.g., refined oil) the plant may be capable of producing (e.g., how much final product the plant may be capable of producing within allowable safety limits). As another example, plant efficiency data may indicate the efficiency of one or more processes the plant is performing. As another example, plant process data may indicate the process (e.g., the order of operations for one or more tasks) the plant performs in order to produce a final product from one or more input ingredients. As another example, flow rate data may include the flow rate of various fluids in different locations throughout the plant (e.g., the flow rate of gas in the stack). As another example, the temperature data may indicate the temperature at various locations in the plant (e.g., temperature in the stack) and/or the boiling point of various fluids in the plant. As another example, the pressure data may indicate the pressure (e.g., the pressure of gas in the stack) at various locations in the plant. As another example, the volume data may indicate the volume (e.g., fluid level in a storage tank) at various locations in the plant. As another example, the oxygen input data may indicate how much oxygen the plant is mixing with the gas before the gas passes by the ignition source and/or simultaneously as the gas passes by the ignition source of the stack. As another example, the material composition data may indicate various properties of a final product the plant is producing (e.g., refined oil) and/or input ingredients the plant is using to produce the final product (e.g., unrefined oil), such as purity, density, viscosity, impurities, and/or the like. As another example, the weather data may indicate the weather around the plant (e.g., the temperature around the plant, wind speed around the plant, humidity around the plant, precipitation around the plant, etc.). As another example, the stationary combustion data may indicate emissions of the plant due to stationary combustion at the plant. As another example, flaring data may indicate emissions of the plant due to flaring at the plant. As another example, fugitive data may indicate fugitive emissions of the plant. As another example, venting data may indicate emissions of the plant due to venting at the plant. In some embodiments, venting data may indicate emissions of the plant due to venting associated with one or more of natural gas driven pneumatic equipment, centrifugal compressor shaft seals, reciprocating compressor rod packing, glycol dehydrators, tanks, well liquids unloading, well casingheads, hydraulic fractures, and/or the like. As another example, the plant level emissions data may indicate total emissions of the plant. As another example, plant measurement emissions data may indicate measured emissions at the plant.

As described above, the operations data may be associated with one or more data generation types. The data generation types may include one or more of a source sampling type, a simulation model type, a process-based emission factors type, a survey type, a material balance type, a census-based emission factors type, and/or an extrapolation type. In some embodiments, each data generation type may indicate a methodology or procedure used to generate some or all of the operations data

As shown in block 604, the method for machine learning based classification of operations data representing operations of a plant may include applying the operations data to an operations data classification model. As described above, in some embodiments, the operations data classification model may include a trained machine learning model that classifies the operations data into one or more classification levels based at least in part on one or more of the one or more data generation types. In this regard, the one or more classification levels may include a first level, a second level, a third level, a fourth level, and a fifth level. In some embodiments, the first level is associated with an asset-based reporting, the second level is associated with source-based reporting, the third level is associated with source-based reporting and emissions factors-based reporting, the fourth level is associated with source-based reporting, emissions factors based-reporting, and activity factors-based reporting, and the fifth level is associated with emissions factors based-reporting, activity factors-based reporting, and plant measurement emissions based-reporting. For example, asset-based reporting may include operations data that indicates the total emissions of an asset, such as the plant (e.g., plant level emissions data). As another example, source-based reporting may include operations data indicating emissions associated with one or more units (e.g., a venting unit) of an asset, such as the plant (e.g., venting data). As another example, emissions factors based-reporting may include operations data indicating emissions associated with one or more emissions factors associated with the plant. As another example, activity factors may include operations data indicating emissions associated with a measured quantity associated with a particular activity at the plant (e.g., venting data indicating measured emissions due to venting when a compressor unit starts). As another example, plant measurement emissions based-reporting may indicated emissions measured at the plant (e.g., plant measurement emissions data).

As shown in block 606, the method for machine learning based classification of operations data representing operations of a plant may include generating an operations data classification report that is specially configured based at least in part on the one or more classification levels and the operations data. As described above, in some embodiments, the operations data classification report may include a plurality of classification sections. In some embodiments, each classification section of the plurality of classification sections may correspond to one of the one or more classification levels. In this regard, for example, the operations data classification report may include a first level classification section, a second level classification section, a third level classification section, a fourth level classification section, and a fifth level classification section.

As shown in block 608, the method for machine learning based classification of operations data representing operations of a plant may optionally include generating a simulation model of the plant based at least in part on historical operations data. As described above, in some embodiments, the simulation model may be a computer model representation of the plant based on the operations data and/or historical operations data. In this regard, for example, the simulation model may include one or more well components, fracking components, heater components 406, pump components, storage tank components, venting components, compressor components, cooler components, sensor components, flare components, and/or weather components. In some embodiments, the components included in the simulation model may be based on the operations data and/or the historical operations data. For example, if the operations data and/or the historical operations data includes a plant component identifier that indicates the plant has a fracking component, the simulation model may include a fracking component. As another example, if the operations data and/or the historical operations data includes flow rate data, the simulation model may include a sensor component corresponding to a flow sensor. As another example, if the operations data and/or the historical operations data indicates wind speed around the plant, the simulation model may include a weather component corresponding to the wind speed around the plant.

As shown in block 610, the method for machine learning based classification of operations data representing operations of a plant may optionally include applying the simulation model to generate an emissions dataset. As described above, in some embodiments, the emissions dataset may include a training emissions dataset and/or a test emissions dataset (e.g., the emissions dataset may be divided into a training emissions dataset and/or a test emissions dataset). In some embodiments, the emissions dataset may comprise data that indicates the emissions of the plant. In this regard, applying the simulation model to generate the emissions dataset may include the simulation model determining one or more physical properties or chemical properties associated with the plant. For example, the one or more physical properties associated with the plant may include one or more of a melting point associated with a product produced by the plant and/or input ingredient used by the plant and/or a molecular weight associated with a product produced by the plant and/or input ingredient used by the plant. As another example, the one or more chemical properties associated with the plant may include one or more of a flammability associated with a product produced by the plant and/or input ingredient used by the plant (e.g., gas in the stack) and/or a pH value associated with a product produced by the plant and/or input ingredient used by the plant. Said differently, the emissions data set may include the one or more physical or chemical properties determined by applying the simulation model such that the emissions dataset includes data that indicates the emissions of the plant.

As shown in block 612, the method for machine learning based classification of operations data representing operations of a plant may optionally include training the trained machine learning model. As described above, in some embodiments, training the machine learning model may include the trained machine learning model applying one or more machine learning techniques on the training emissions dataset to generate a trained emissions dataset. In some embodiments, the one or more machine learning techniques may be an unsupervised learning technique, such as a clustering technique. For example, the clustering technique may be a k-means clustering technique. In this regard, applying one or more machine learning techniques on the training emissions dataset may include iteratively grouping data in the training emissions dataset into clusters, where the data in each cluster has similar characteristics, to generate the trained emissions dataset. Additionally or alternatively, the one or more machine learning techniques may include a supervised learning technique, such as a regression technique. In some embodiments, after generating the trained emissions dataset, training the machine learning model may further include compare the trained emissions dataset to the test dataset. In this regard, a confidence level may be calculated indicating the accuracy of the trained emissions dataset.

As shown in block 614, the method for machine learning based classification of operations data representing operations of a plant may optionally include generating a user interface configured to display the operations data classification report. As described above, in some embodiments the user interface may be configured to display the operations data classification report. In some embodiments, generating the user interface includes generating a plurality of classification interface components with each classification interface component configured to automatically display a corresponding classification section of the plurality of classification sections of the operations data classification report. For example, the plurality of classification interface components may include a first level classification interface component corresponding to the first level, a second level classification interface component corresponding to the second level, a third level classification interface component corresponding to the third level, a fourth level classification interface component corresponding to the fourth level, and a fifth level classification interface component corresponding to the fifth level.

As described above, in some embodiments, each of the plurality of classification interface components may be configured to automatically display the operations data classified into the classification level corresponding the classification interface component (e.g., automatically after the trained machine learning model has classified the operations data into the one or more classification levels). For example, the first level classification interface component may automatically display a plurality of first level operations data. As another example, the second level classification interface component may automatically display a plurality of second level operations data. As another example, the third level classification interface component may automatically display a plurality of third level operations data. As another example, the fourth level classification interface component may automatically display a plurality of fourth level operations data. As another example, the fifth level classification interface component may automatically display a plurality of fifth level operations data.

As described above, in some embodiments, each of the plurality of classification interface components may be configured to automatically display particular emissions values associated with the operations data in each classification level. For example, the first level classification interface component may include first level emissions values. For example, the second level classification interface component may plurality of second level emissions values. For example, the third level classification interface component may a plurality of third level emissions values. For example, the fourth level classification interface component may a plurality of fourth level emissions values. For example, the fifth level classification interface component may a plurality of fifth level emissions values. In some embodiments, the particular emissions values may be indicative of one or more greenhouse gases (e.g., methane) related to the associated operations data.

As described above, in some embodiments, the user interface may be configured to be updated. In this regard, for example, the operations data and/or the particular emissions values associated with the operations data in one or more of the classification interface components may be updated. In some embodiments, the user interface may be updated via user selection. For example, a user may update the user interface via update component. In some embodiments, the user interface may be updated in real-time. For example, the user interface may be updated as operations data is received and/or as the trained machine learning model classifies the operations data into the one or more classification levels. In some embodiments, the user interface may be updated on a periodic basis. For example, the user interface may be updated one per hour, once per day, once per week, once per month, once per quarter, and the like. In some embodiments, the user interface is updated in response to any other particular data-driven trigger, for example receiving a user engagement, detecting a particular data signal, detecting a data value that satisfies a particular threshold, and/or the like.

Operations and/or functions of the present disclosure have been described herein, such as in flowcharts. As will be appreciated, computer program instructions may be loaded onto a computer or other programmable apparatus (e.g., hardware) to produce a machine, such that the resulting computer or other programmable apparatus implements the operations and/or functions described in the flowchart blocks herein. These computer program instructions may also be stored in a computer-readable memory that may direct a computer, processor, or other programmable apparatus to operate and/or function in a particular manner, such that the instructions stored in the computer-readable memory produce an article of manufacture, the execution of which implements the operations and/or functions described in the flowchart blocks. The computer program instructions may also be loaded onto a computer, processor, or other programmable apparatus to cause a series of operations to be performed on the computer, processor, or other programmable apparatus to produce a computer-implemented process such that the instructions executed on the computer, processor, or other programmable apparatus provide operations for implementing the functions and/or operations specified in the flowchart blocks. The flowchart blocks support combinations of means for performing the specified operations and/or functions and combinations of operations and/or functions for performing the specified operations and/or functions. It will be understood that one or more blocks of the flowcharts, and combinations of blocks in the flowcharts, can be implemented by special purpose hardware-based computer systems which perform the specified operations and/or functions, or combinations of special purpose hardware with computer instructions.

While this specification contains many specific embodiments and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

While operations and/or functions are illustrated in the drawings in a particular order, this should not be understood as requiring that such operations and/or functions be performed in the particular order shown or in sequential order, or that all illustrated operations be performed, to achieve desirable results. In certain circumstances, operations and/or functions in alternative ordering may be advantageous. In some cases, the actions recited in the claims may be performed in a different order and still achieve desirable results. Thus, while particular embodiments of the subject matter have been described, other embodiments are within the scope of the following claims.

While this specification contains many specific embodiment and implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are illustrated in the drawings in a particular order, this should not be understood as requiring that such operations be performed in the particular order shown or in sequential order, or that all illustrated operations be performed, to achieve desirable results. In certain circumstances, operations in alternative ordering may be advantageous. In some cases, the actions recited in the claims may be performed in a different order and still achieve desirable results.

That which is claimed:

1. A computer-implemented method for machine learning based classification of operations data representing operations of a plant, the computer-implemented method comprising:
receiving the operations data representing the operations of the plant, wherein the operations data is associated with one or more data generation types;
applying the operations data to an operations data classification model, wherein the operations data classification model comprises a trained machine learning model that classifies the operations data into one or more classification levels based at least in part on the one or more data generation types; and
generating an operations data classification report that is specially configured based at least in part on the one or more classification levels and the operations data.

2. The computer-implemented method of claim 1, wherein the one or more data generation types include a source sampling type, a simulation model type, a process-based emission factors type, a survey type, a material balance type, a census-based emission factors type, and an extrapolation type.

3. The computer-implemented method of claim 1, wherein the one or more classification levels comprise a first level, a second level, a third level, a fourth level, and a fifth level.

4. The computer-implemented method of claim 3, wherein the first level is associated with an asset-based reporting, the second level is associated with source-based reporting, the third level is associated with source-based reporting and emissions factors-based reporting, the fourth level is associated with source-based reporting, emissions factors based-reporting, and activity factors-based reporting, and the fifth level is associated with source-based reporting, emissions factors based-reporting, activity factors-based reporting, and plant measurement emissions based-reporting.

5. The computer-implemented method of claim 1, further comprising:
generating a simulation model of the plant based at least in part on historical operations data; and
applying the simulation model to generate an emissions dataset, wherein the emissions dataset comprises a training emissions dataset and a test emissions dataset.

6. The computer-implemented method of claim 5, further comprising:
training the trained machine learning model, wherein training the trained machine learning comprises:
applying, by the trained machine learning model, one or more machine learning techniques on the training emissions datasets to generate a trained emissions dataset; and
comparing the trained emissions dataset to the test emissions dataset.

7. The computer-implemented method of claim 6, wherein the one or more machine learning techniques comprises a clustering technique.

8. The computer-implemented method of claim 7, wherein the clustering technique comprises a k-means clustering technique.

9. The computer-implemented method of claim 6, wherein the one or more machine learning techniques comprises a regression technique.

10. The computer-implemented method of claim 1, wherein the operations data classification report includes a plurality of classification sections, each classification section of the plurality of classification sections corresponding to one of the one or more classification levels.

11. The computer-implemented method of claim 10, further comprising:
generating a user interface configured to display the operations data classification report.

12. The computer-implemented method of claim 11, wherein generating the user interface comprises generating a plurality of classification interface components, each classification interface component configured to automatically display a corresponding classification section of the plurality of classification sections.

13. The computer-implemented method of claim 12, wherein each classification interface component is configured to automatically display the operations data classified into the classification level corresponding to the classification interface component.

14. An apparatus for machine learning based classification of operations data representing operations of a plant, the apparatus comprising at least one processor and at least one non-transitory memory including computer-coded instructions thereon, the computer coded instructions, with the at least one processor, cause the apparatus to:
receive the operations data representing the operations of the plant, wherein the operations data is associated with one or more data generation types;
apply the operations data to an operations data classification model, wherein the operations data classification model comprises a trained machine learning model that classifies the operations data into one or more classification levels based at least in part on the one or more data generation types; and
generate an operations data classification report that is specially configured based at least in part on the one or more classification levels and the operations data.

15. The apparatus of claim 14, wherein the one or more data generation types include a source sampling type, a simulation model type, a process-based emission factors type, a survey type, a material balance type, a census-based emission factors type, and an extrapolation type.

16. The apparatus of claim 14, wherein the computer coded instructions, further with the at least one processor, cause the apparatus to:
generate a simulation model of the plant based at least in part on historical operations data; and
apply the simulation model to generate an emissions dataset, wherein the emissions dataset comprises a training emissions dataset and a test emissions dataset.

17. The apparatus of claim 16, wherein the computer coded instructions, further with the at least one processor, cause the apparatus to:
train the trained machine learning model, wherein training the trained machine learning comprises:
applying, by the trained machine learning model, one or more machine learning techniques on the training emissions datasets to generate a trained emissions dataset; and
comparing the trained emissions dataset to the test emissions dataset.

18. The apparatus of claim 14, wherein the operations data classification report includes a plurality of classification sections, each classification section of the plurality of classification sections corresponding to one of the one or more classification levels.

19. The apparatus of claim 18, wherein the computer coded instructions, further with the at least one processor, cause the apparatus to:
generating a user interface configured to display the operations data classification report, wherein generating the user interface comprises generating a plurality of classification interface components, each classification interface component configured to automatically display a corresponding classification section of the plurality of classification sections, wherein each classification interface component is configured to automatically display the operations data classified into the classification level corresponding to the classification interface component.

20. A computer program product for machine learning based classification of operations data representing operations of a plant, the computer program product comprising at least one non-transitory computer-readable storage medium having computer program code stored thereon that, in execution with at least one processor, configures the computer program product for:
receiving the operations data representing the operations of the plant, wherein the operations data is associated with one or more data generation types;
applying the operations data to an operations data classification model, wherein the operations data classification model comprises a trained machine learning model that classifies the operations data into one or more classification levels based at least in part on the one or more data generation types; and
generating an operations data classification report that is specially configured based at least in part on the one or more classification levels and the operations data.
